(19) United States
(12) Patent Application Publication
(10) Pub. No.: US 2010/0176951 A1
(43) Pub. Date: Jul. 15, 2010

(54) SURVEILLANCE DEVICE

(75) Inventor: Ulrich Zinner, Philadelphia (ZA)

Correspondence Address: CONNOLLY BOVE LODGE & HUTZ LLP, 1875 EYE STREET, N.W., SUITE 1100, WASHINGTON, DC, 20006, US

(73) Assignee: BELL-OAK INVESTMENT (PROPRIETARY) LIMITED, Philadelphia (ZA)

(21) Appl. No.: 12/518,038

(22) PCT Filed: Dec. 6, 2007
(86) PCT No.: PCT/IB2007/054954

§ 371 Date: Nov. 2, 2009

(30) Foreign Application Priority Data
Dec. 6, 2006 (ZA) 2006/10198

(51) Int. Cl. G08B 13/14

(52) U.S. Cl. 340/572.9

(57) ABSTRACT

A surveillance device in the form of an EAS tag (10) is provided, which includes a body (12) with one or more EAS markers (16) inside an inner cavity of the housing. The tag (10) further includes a detent (18) with one end (46) that is pivotally attached to the body (12) so that the detent (18) can pivot relative to the body (12) between an open condition and a locked condition and with a second end (52) that is releasably attachable to the body (12) when in the locked condition. When in the locked condition, the combination of the body (12) and a part of the detent (18) between its ends (46,52), encloses a space (20) adjacent the body (10) and an article such as an arm (32) of a spectacle frame can be gripped in the space. The tag (10) allows for tight gripping of various sizes of spectacle arms (32) by allowing the size of the space (20) to be adjusted.

### FIELD OF THE INVENTION

This invention relates to electronic article surveillance (EAS) security devices or security tags that can be applied to articles such as merchandise to inhibit theft or pilfering. In particular, the invention relates to re-usable EAS tags suitable for surveillance of spectacle frames.

### BACKGROUND TO THE INVENTION

Security devices in the form of tags that can be attached to merchandise in EAS systems are widely used to alert retailers to unauthorised removal of tagged merchandise from their premises. The tags can be disposable or re-usable and a re-usable tag typically includes a body housing an EAS marker (also known in the art as a “sensor”). The body can be attached to the merchandise it is intended to protect and this is typically done by with the aid of a tack with a shank that can pass through an article of merchandise and that can be received in an aperture in the tag body, where it is held firmly to prevent removal of the tag from the article of merchandise.

However, the use of this type of EAS tag requires the article to include an aperture or penetrable part through which the shank can pass and in the case of many articles or merchandise such as spectacle frames, the material and/or geometry of the articles prevents these tags from being securely attached to the articles. It is particularly difficult to attach tags to articles such as spectacle frames where the only parts of the frames to which tags can be attached without preventing the spectacles from being tested by potential wearers, are the arms, which are thin and long without large stop formations at their ends. The thicknesses or diameters of the arms vary between different spectacles and the padding at the end of the arms is often not significantly thicker than the arms of some spectacles.

The present it seeks to provide a cost effective surveillance device that can be securely, but removably attached to articles such as spectacle frames that have one or more elongate parts. The invention further seeks to provide such a surveillance device that can house multiple sensors, preferably different types of sensors and that is compact.

### SUMMARY OF THE INVENTION

According to the present invention there is provided a surveillance device comprising:
a body defining an inner cavity; and
at least one marker inside the cavity, said marker being configured to emit a signal;
wherein said device further includes a detent with a first end of said detent being pivotally attached to the body so that said detent is displaceable relative to the body between an open condition and a locked condition and with a second end of said detent being releasably attachable to the body when in said locked condition, such that the combination of the body and a part of the detent extending between said first and second ends, encloses a space adjacent the body when in said closed condition.

I this specification, the term “surround” is intended to mean extending continuously around, but not necessarily in all directions.

The attachment of the ends of the detent to the body may allow the detent to be attached to the body in a plurality of positions, resulting in different sizes of the surrounded space between the detent and the body, which allows different sizes of articles, such as different diameters of spectacle frame arms, to be gripped within the space.

In particular, the attachment of the first end of the detent to the body may be in a plurality of locations, e.g. the first end of the detent may be receivable in one of a plurality of recesses and may be held captive in one of the recesses when in the looked condition. In such an arrangement, the device may include a cam arrangement that is configured to urge first end of the detent towards a recess when the detent is pivoted from the open to the locked condition.

Further, the device may include a ratchet arrangement configured to allow the second end of the detent to be held selectively (i.e. when desired) against pivoting to the open condition, while allowing the second end to pivot towards the lock condition. The ratchet arrangement may thus allow the second end to be held in a plurality of positions, when in the lock condition.

The body may define an aperture in which the second end is receivable in the lock condition and the ratchet mechanism may be disposed in the aperture.

The device may include a compressible member such as a pad adjacent the space surrounded by the combination of the body and the detent when in the lock condition.

The device may include one or more of the markers of selected from an acousto-magnetic marker, an electromagnetic marker, and a radio frequency marker and may preferably include a plurality of these markers. In a preferred embodiment, the device may include more than one marker of different types or a marker configured to emit different types of signals. The preferred embodiment of the device may thus be a “multi frequency” device that is capable of emitting two or more of: acoustic (AM) radio (RE) or electromagnetic (EM) signals.

### BRIEF DESCRIPTION OF THE DRAWINGS

For a better understanding of the present invention and to show how it may be carried into effect, the invention will now be described by way of non-limiting example with reference to the accompanying drawings, in which:

FIG. 1 shows a top view of a surveillance device in accordance with the present invention;

FIG. 2 shows a sectional side view of the surveillance device of FIG. 1, taken at II-II;

FIG. 3 shows a sectional top view of the surveillance device of FIG. 2, taken at III-III;

FIG. 4 shows a sectional side view of the surveillance device shown in FIG. 2, in an open condition;

FIG. 5 shows a sectional side view of the surveillance device show in FIG. 2 in a closed condition attached to a spectacle frame with a large diameter;

FIG. 6 shows a sectional side view of the surveillance device shown in FIG. 2 in the closed condition attached to a spectacle frame with a small diameter;

FIG. 7 shows a top vies of a detacher for use with the surveillance device of FIGS. 1 to 6;

FIG. 8 shows a top view of the detacher of FIG. 7 with the surveillance device of FIGS. 1 to 6; and

FIG. 9 shows a perspective view of the surveillance device of FIGS. 1 to 6, attached to a spectacle frame.

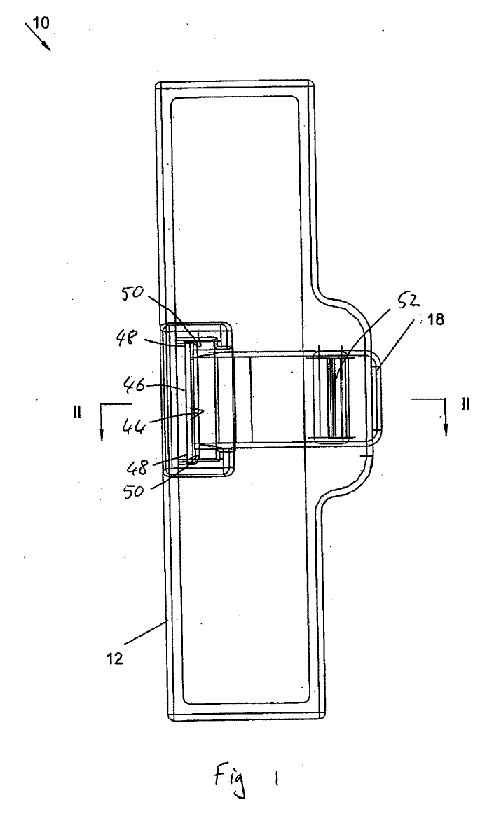

### DETAILED DESCRIPTION OF THE DRAWINGS

Referring to the drawings, a surveillance device in the form of an EAS tag in accordance with the present invention is generally indicated by reference numeral 10.

The tag 10 includes an elongate body 12 of synthetic plastics material that defines an internal cavity 14 inside the body inside which one or more EAS markers 16 are fitted. The body 10 comprises of various parts which are attached to one another by welding (e.g. ultra-sonic welding), fusing, adhesive, or the like, to encase the markers 16. Further, the plastics material of the body 12 is sufficiently resilient to protect the markers against damage.

The markers 16 are configured to emit signals that can be detected in EAS security systems, e.g. the markers can be acousto-magnetic (AM) markers, electro magnetic (EM) markers, radio frequency (RF) markers such as identification markers (RHO markers). The tag 10 can include only a single marker 16, but in a preferred embodiment, it can include multiple markers that are configured to emit different types of signals. In the preferred embodiment, the tag 10 is thus a “multiple frequency” tag that is capable of emitting two or more signals.

The tag 10 further includes a locking member or detent 18 that is displaceable relative to the body 12 and that can extend partly around a space 20 between the body and the detent. The detent 18 is releasably connectable to the body 12 and can be displaced relative to the body between a dosed condition of the tag 10 in which the space 20 is fully surrounded by the combination of the body 12 and the detent 18 and an open condition in which the space 20 is not surrounded in full.

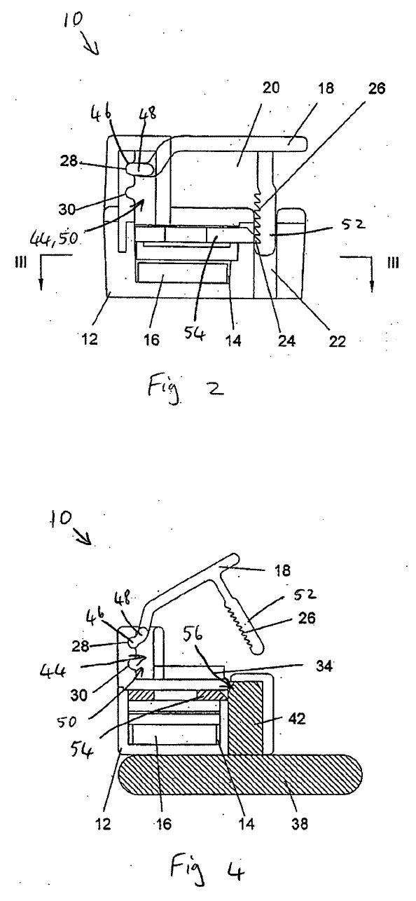

The detent 18 is generally L-shaped in side view, as can be seen in FIGS. 2 and 4 to 6, with the space 20 on the inside of its L-profile. The body 12 defines a pivot cavity 44 in which a first or pivot end 46 of the detent 18 is held captive by lateral protuberances 48 that are received in complementally configured recesses 50 on either side of the pivot cavity. Inside the pivot cavity 44, two recesses 28 and 30 are defined in which the pivot end 46 can be received and each protuberance 48 has an elongate profile that can press against the inside of its associated recess 50 when the detent 18 is pivoted, so that the protuberances 48 act cam fashion against the recess to urge the pivot end 46 into one of the recesses 28 or 30, to hold it in position relative to the body 12.

The pivot cavity 44 may define more than two recesses 28,30 and the function of the configuration described in the preceding paragraph is to hold the pivot end 46 captive inside the pivot cavity, yet to allow the detent 18 to pivot relative to the body and to allow the pivot end 46 to be selectively locked into to different positions inside the pivot cavity, with the result that the size and shape of the space 20 can be varied by selecting different recesses 28,30 in which the pivot end 46 is received and retained.

At the end of the L-shape of the detent 18 that is opposite from the pivot end 46, it has a second or lock end 52 which defines a lock formation in the form of a series of angled ridges or teeth 26 with grooves between them. Further, the body 12 defines an aperture 22 into which the lock end 52 of the detent can slide when the detent 18 pivots relative to the body. The body 12 also houses a displaceable lock element with an oppositely angled edge 24 that protrudes into the aperture 22 and that can engage the lock end 52 by gripping the teeth 26, The lock element 54 is biased towards the aperture 22 by a spring or the like (not shown) and this, together with the angled orientation of the teeth 26 and edge 24, causes the edge to engage the teeth in a ratchet arrangement.

The part of the body 12 that faces the detent 18, i.e. the part of the body adjacent the space 20, is provided with a resiliently flexible pad 34 made of an elastomeric material such as rubber.

Two recesses 40 are defined in the underside of the body 12 on opposite sides of the aperture 22 and the edge 24 protrudes also into these recesses, under the bias of the spring.

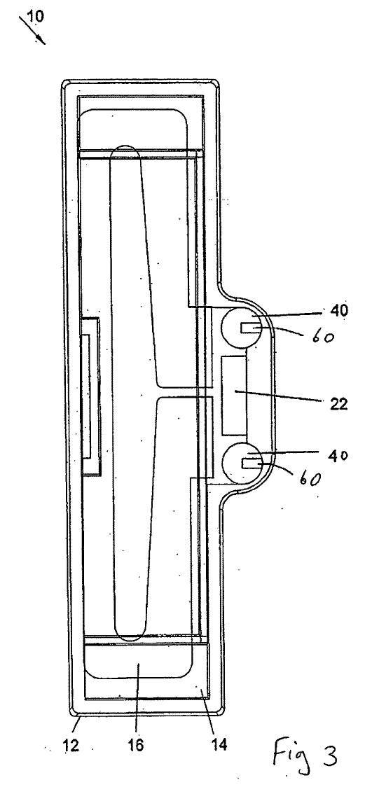

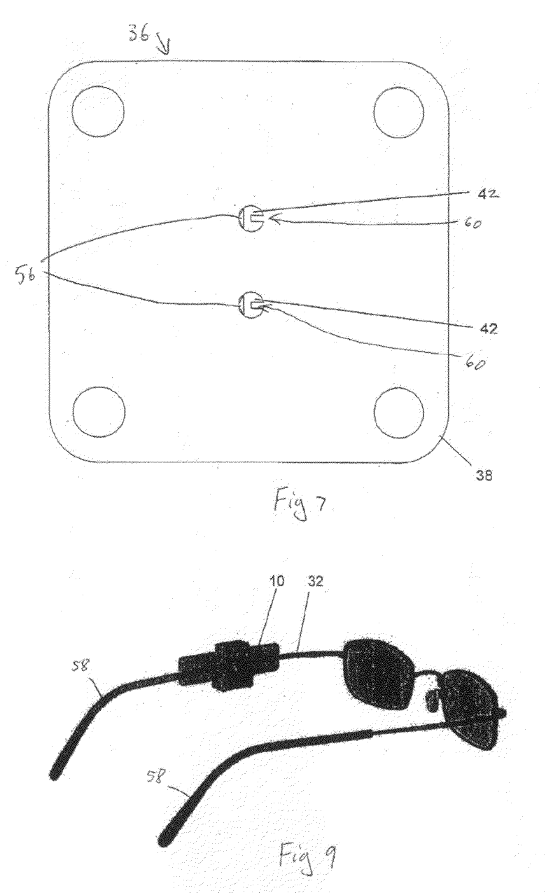

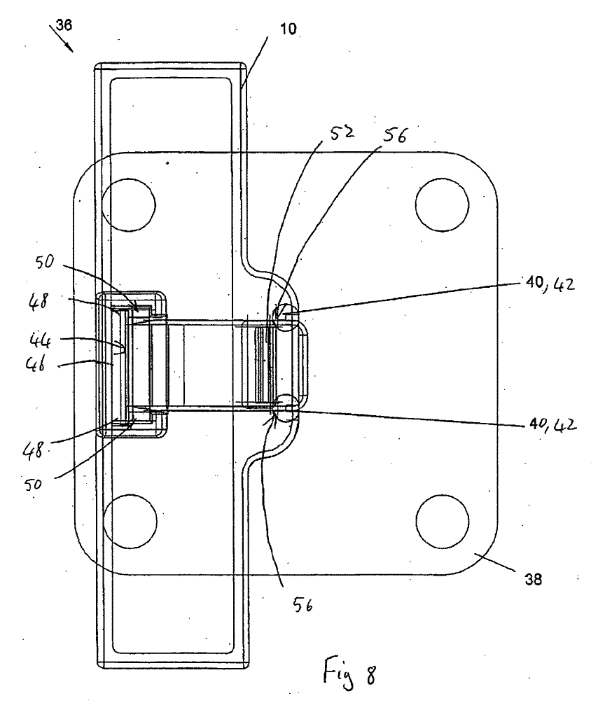

As can be seen in FIGS. 4, 7 and 8, a detaches 36 for use with the tag 10 includes a base 38 with two protuberances 42 that are shaped and dimensioned complementally to the recesses 40. Each protuberance 42 defines a beveled or inclined surface 56 on its one side.

In use, when a spectacle frame needs to be tagged, the detent 18 is pivoted upwardly relative to the body 12 to the open condition of the tag 10 shown in FIG. 4 and the arm 32 of the frame is positioned to extend along the body, adjacent the padding 34. Depending on the thickness or diameter of the arm 32, the pivot end 46 of the detent 18 is inserted into either of the recess 28 or 30 and the detent is pivoted downwardly to the locked condition of the tag 10, while the protuberances 48 urges the pivot end 46 to be locked relative to the recess 28 or 30. Further, while the detent 18 is pivoted downwardly, its lock end 52 enters the aperture 22 and the edge 24 grips the teeth 26 in a ratchet manner, to hold the lock end captive against withdrawing from the aperture 22.

The detent 18 is pivoted downwardly until it presses tightly against the spectacle arm 32, which in turn presses tightly against the pad 34 and compresses the pad so that the pad grips the arm. The tag 10 is now in its locked condition, with the space 20 entirely surrounded by the combination of the body 12 and the detent 18. The tag 10 is prevented from sliding off the arm 32 by the tight pinching grip between the detent 18 and the body 12, combined by the grip of the pad 34. The tight pinching grip that conforms so closely to the diameter of the arm 32 also ensures that, even if the tag 10 were to be slid longitudinally along the arm, it would not be possible to slide it over any significant widening at the end of the arm, such as the padding 52 that is present on practically all spectacle frames.

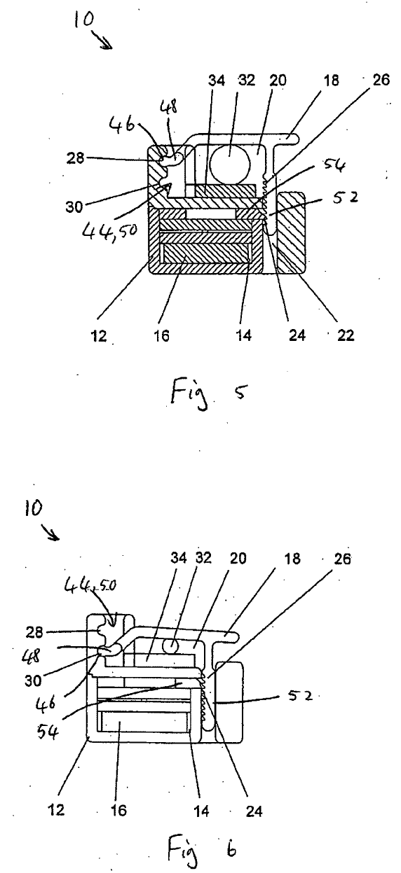

The adaptability of the tag 10 to grip different sizes or diameters of spectacle frame arms 32 tightly can be seen when FIGS. 5 and 6 are compared. In FIG. 5, the pivot end 46 is received in the recess 28 and the lock end 52 is gripped near its end by the lock element 54, so that the space 20 is relatively large and the relatively thick arm 32 is gripped tightly. By contrast, in FIG. 6, the pivot end 46 is received in the recess 30 and the lock end 52 is gripped further from its end by the lock element 54, so that the space 20 is relatively small and the relatively thin arm 32 is gripped tightly.

When the tag 10 needs to be removed from the spectacle frame, the tag is pressed against the detacher 36 such that the protuberances 42 enter the recesses 40, The beveled surfaces 56 of the protuberances 42 slide along the edge 24 on either side of the lock end 52 and the angled orientation of the beveled surfaces 56 urges the lock element 54 against its bias away from the lock end 52 in a wedge fashion and thereby causes the edge 24 to be withdrawn from the teeth 26, This frees the lock end 42 so that it can be withdrawn from the aperture 22 and the detent 18 can be pivoted upwardly to the open condition of the tag and the arm 32 can be removed from the space 20.

In order to inhibit tampering with the tag 10 or its unauthorized removal from the spectacle tag, the geometries of the recesses 40 and protuberances 42 are more complex that simple shapes such as circles or squares and can include keyways 60 or the like. This adds to the security of the tags 10 that can only be removed from the spectacle arm 32 with a detacher 36 with correctly profiled protuberances 42.

The configuration of the tag 10 allows it to be made compact and to extend closely along the arm 32 of the spectacle in a manner and orientation that allows the spectacle frame to be tried on and that allows a wearer to evaluate the spectacle frame before purchasing it, as is typically done in a retail environment. Further, the configuration of the tags 10 allows them to be made at relatively low cost, either as disposable or reusable tags.

1. A surveillance device comprising:
a body defining an inner cavity; and
at least one marker inside the cavity, said marker being configured to emit a signal;
characterised in that said device further includes a detent with a first end of the detent being pivotally attached to the body so that said detent is displaceable relative to the body between an open condition and a locked condition and with a second end of the detent being releasably attachable to the body when in said locked condition, such that the combination of the body and a part of the detent extending between said first and second ends, encloses a space adjacent the body when in said closed condition.

2. A surveillance tag as claimed in claim 1, characterised in that the attachment of said ends of the detent to the body allows the detent to be attached to the body in a plurality of positions.

3. A surveillance device as claimed in claim 2, characterised in that the attachment of said first end of the detent to the body can be in a plurality of locations.

4. A surveillance device as claimed in claim 3, characterised in that said first end of the detent is receivable in one of a plurality of recesses and is held captive in one of said recesses when in said locked condition.

5. A surveillance device as claimed in claim 4, characterised in that said device includes a cam arrangement that is configured to urge first end of the detent towards a recess when the detent is pivoted from the open to the locked condition.

6. A surveillance device as claimed in claim 1, characterised in that said device includes a ratchet arrangement configured to allow said second end of the detent to be held selectively against pivoting to said open condition, while allowing said second end to pivot towards said lock condition.

7. A surveillance device as claimed in claim 1, characterised in that said body defines an aperture in which said second end is receivable in the lock condition.

8. A surveillance device as claimed in claim 1, characterised in that said device includes a compressible member adjacent said space.

9. A surveillance device as claimed in claim 1, characterised in that said device includes at least one of said markers selected from an acousto-magnetic marker, an electromagnetic marker, and a radio frequency marker.

10. A surveillance device as claimed in claim 9, characterised in that said device includes a plurality of said markers.

11. A surveillance device as claimed in claim 2, characterised in that said device includes a ratchet arrangement configured to allow said second end of the detent to be held selectively against pivoting to said open condition, while allowing said second end to pivot towards said lock condition.

12. A surveillance device as claimed in claim 3, characterised in that said device includes a ratchet arrangement configured to allow said second end of the detent to be held selectively against pivoting to said open condition, while allowing said second end to pivot towards said lock condition.

13. A surveillance device as claimed in claim 4, characterised in that said device includes a ratchet arrangement configured to allow said second end of the detent to be held selectively against pivoting to said open condition, while allowing said second end to pivot towards said lock condition.

14. A surveillance device as claimed in claim 5, characterised in that said device includes a ratchet arrangement configured to allow said second end of the detent to be held selectively against pivoting to said open condition, while allowing said second end to pivot towards said lock condition.

15. A surveillance device as claimed in claim 2, characterised in that said body defines an aperture in which said second end is receivable in the lock condition.

16. A surveillance device as claimed in claim 3, characterised in that said body defines an aperture in which said second end is receivable in the lock condition.

17. A surveillance device as claimed in claim 4, characterised in that said body defines an aperture in which said second end is receivable in the lock condition.

18. A surveillance device as claimed in claim 5, characterised in that said body defines an aperture in which said second end is receivable in the lock condition.

19. A surveillance device as claimed in claim 6, characterised in that said body defines an aperture in which said second end is receivable in the lock condition.

20. A surveillance device as claimed in claim 2, characterised in that said device includes a compressible member adjacent said space.
